(19) United States
(12) Patent Application Publication
(10) Pub. No.: US 2016/0341991 A1
(43) Pub. Date: Nov. 24, 2016

(54) VERTICAL ALIGNMENT LIQUID CRYSTAL DISPLAY

(71) Applicant: SHENZHEN CHINA STAR OPTOELECTRONICS TECHNOLOGY CO., Shenzhen, Guangdong (CN)

(72) Inventors: Yungjui LEE, Shenzhen, Guangdong (CN); Xinhui ZHONG, Shenzhen, Guangdong (CN)

(73) Assignee: SHENZHEN CHINA STAR OPTOELECTRONICS TECHNOLOGY CO., Shenzhen, Guangdong (CN)

(21) Appl. No.: 14/423,691

(22) PCT Filed: Feb. 9, 2015
(86) PCT No.: PCT/CN2015/072502

§ 371 Date: Feb. 24, 2015

(51) Int. Cl. G02F 1/1337; G02F 1/1362; G02F 1/1335; G02F 1/1368

(52) U.S. Cl. CPC G02F 1/1337; G02F 1/1368; G02F 1/136286; G02F 1/136227; G02F 1/133514; G02F 2201/123; G02F 2001/133302

(57) ABSTRACT

The present invention provides a vertical alignment liquid crystal display, improving the present liquid crystal display of which the vertical alignment is implemented to the liquid crystal molecules with auxiliary alignment agent, and by forming the passivation layer (26) and a contact layer of the pixel electrode (27) to be oxide layers of which the surface property is similar with the pixel electrode; or by forming a flat layer (28) covering the pixel electrode (27), an acting force of the auxiliary alignment agent (31) dissolved in the liquid crystal layer (3) and the surface of the TFT substrate (2) is homogenized to solve the defect problems of aligning force difference and bright, dark lines display caused by the patterning of the pixel electrode (27).

### FIELD OF THE INVENTION

The present invention relates to a display technology field, and more particularly to a vertical alignment liquid crystal display.

### BACKGROUND OF THE INVENTION

The LCD (Liquid Crystal Display) possesses many advantages of being ultra thin, power saved and radiation free. It has been widely utilized in, such as LCD TVs, mobile phones, Personal Digital Assistant (PDAs), digital cameras, laptop screens or notebook screens.

For the TFT-LCD panels in the present main market, three types can be illustrated, which respectively are Twisted Nematic/Super Twisted Nematic (TN/STN), In-Plane Switching (IPS) and Vertical Alignment (VA). The VA liquid crystal display possesses extremely high contrast than the liquid crystal displays of other types, which can reach up to 4000-8000 in general. It has very wide application in large scale display, such as television or etc.

The reason why the VA liquid crystal display possesses extremely high contrast is that the liquid crystal molecules are vertically aligned to the substrate surface, and no phase difference exists, and light leakage is very small at the dark state without applying electricity. The lower the brightness at the dark state can be, the higher the contrast is. As shown in FIG. 1, for vertically aligning the liquid crystal molecules in the VA liquid crystal display to the substrate surface, the liquid crystal molecules 300 require vertical alignment process. The most common method is to coat the alignment agent in specific districts at the inner surfaces of the upper substrate 100 and the lower substrate 200, and the alignment agent generally contains a mass of chemical solvents, N-methylpyrrolidone (NMP) and polymer material (Polyimide, PI). Then, the substrate is baked for a long time under high temperature (200 degree above in general) to cure the solvent in the alignment agent, and thus, to form the PI alignment layer 310 on the surfaces of the glass substrates.

For earning better wide view angle property for the VA liquid crystal display, the multi-domain VA (MVA) technology is commonly utilized, which is to divide a sub pixel into many districts and drive the liquid crystals in respective districts to lie down toward different directions as applying voltage. Thus, the watch results from respective directions can be equal. There are many ways to realize MVA technology. Please refer to FIG. 2 and FIG. 3. One is to form a pozidriv slit pattern on the Indium Tin Oxide pixel electrode 800 at one side, and with the special ITO pixel electrode pattern, the tilt electric field can induce the liquid crystal molecules 300 to lie down toward different directions. FIG. 2 is a top view diagram of one side of a lower substrate 200 in an MVA liquid crystal display according to prior art, wherein 210 and 220 respectively are scan line and data line. FIG. 3 is a sectional diagram of an MVA liquid crystal display according to prior art, wherein 700 is a passivation layer of which the material is silicon nitride (SiNx).The MVA liquid crystal display has advantages of simple process, high contrast, high aperture ratio and short response time.

However, for realizing the VA alignment, the vertical alignment agent has to be coated on the substrate surface and high temperature baking process has to implement. Because the alignment agent contains a large amount of NMP solvent, thus, the alignment layer formation process is a high energy consumptive, extremely non-environmental protective and human body harmful procedure; besides, due to the problems of non-uniformity, lack coating, non-stick and foreign matter of the alignment layer, the yield lost of the production can occur which results in source waste and increase of the production cost.

In consideration of the above factors, there is a need to develop the VA liquid crystal display in which the PI alignment layer is not needed. As shown in FIG. 4, by changing the recipe of the liquid crystal of adding substance of a sort of auxiliary alignment agent, the liquid crystal molecules 300 can be vertically aligned to the substrate surface of the liquid crystal display under condition without alignment layers. Such kind of auxiliary alignment agent does not need other solvent but can be directly dissolved in the liquid crystal and used with the liquid crystal together. The previous coating equipment and high temperature baking equipment of the alignment agent can be saved. Without the extra solvent, it is cleaner, more environmental protective and energy saved. The function mechanism of the auxiliary alignment agent is, one end of molecules of the auxiliary alignment agent 301 possesses special affinity with inorganic material of the substrate surface, such as silicon nitride constructing the passivation layer 700 or ITO constructing the pixel electrode, and can attach to the surfaces of the substrates, and the other end of molecules of the auxiliary alignment agent 301 has extremely strong acting force with the liquid crystal molecules 300, and thus, the liquid crystal molecules can be induced to be vertical aligned with the surfaces of the substrates. Ultimately, the effect shown in FIG. 4 can be achieved. Because the ITO pixel electrode 800 has a pozidriv slit pattern, the district where the pixel electrode is located is partially covered by the ITO pixel electrode 800, and a portion which is not covered by the ITO pixel electrode 800 is the passivation layer 700, i.e. SiNx at the surface. Without using the PI alignment layer, the alignment relies on the auxiliary alignment agent attaching to the substrate surface, and the difference of ITO and SiNx exists on the substrate surface, which leads to the aligning force difference of the auxiliary alignment agent and the substrate surface and poor alignment. Thus, the defect of dark lines or bright lines can easily occur after the voltage is applied.

Consequently, there is a need to improve the vertical alignment liquid crystal display. Under condition that PI alignment layer is eliminated, and the auxiliary alignment agent is employed for achieving the vertical alignment, the defect problems of aligning force difference and bright, dark lines display caused by the patterning of the MVA pixel electrode can be solved to realize the uniform alignment.

### SUMMARY OF THE INVENTION

An objective of the present invention is to provide a vertical alignment liquid crystal display, improving the present liquid crystal display of which the vertical alignment is implemented to the liquid crystal molecules with auxiliary alignment agent, to solve the defect problems of aligning force difference and bright, dark lines display caused by the patterning of the pixel electrode.

For realizing the aforesaid objective, the present invention provides a vertical alignment liquid crystal display, comprising a CF substrate, a TFT substrate, oppositely located with the CF substrate and a liquid crystal layer located between the CF substrate and the TFT substrate;

the TFT substrate comprises a glass substrate, a gate and a scan line located on the glass substrate, a gate isolation layer being located on the glass substrate and covering the gate and the scan line, an active layer being located above the gate and on the gate isolation layer, a source/a drain located on the active layer and the gate isolation layer, a data line located on the gate isolation layer, a passivation layer being located on the gate isolation layer and covering the source/the drain and the data line and a patterned pixel electrode located on the passivation layer; the pixel electrode contacts with the source/the drain with a passivation layer via hole;

the liquid crystal layer dissolves auxiliary alignment agent, and the auxiliary alignment agent makes the liquid crystal molecules vertically aligned on the surface of the TFT substrate;

the passivation layer at least comprises one layer, wherein a contact layer of the pixel electrode is an oxide layer of which a surface property is similar with the pixel electrode to homogenize an acting force of the auxiliary alignment agent and the surface of the TFT substrate.

The oxide layer of which the surface property is similar with the pixel electrode is a silicon dioxide layer, an aluminum oxide layer, a zirconium oxide layer or a titanium oxide layer.

The passivation layer comprises a double layer or triple layer structure, comprising a topside layer and other layers, and the topside layer is a contact layer of the pixel electrode; the other layers are one or two of the silicon nitride layer, the silicon dioxide layer, the aluminum oxide layer, the zirconium oxide layer or the titanium oxide layer.

The passivation layer comprises a single layer structure, and the single passivation layer is a contact layer of the pixel electrode.

The passivation layer is formed by chemical vapor deposition.

The present invention further provides a vertical alignment liquid crystal display, comprising a CF substrate, a TFT substrate, oppositely located with the CF substrate and a liquid crystal layer located between the CF substrate and the TFT substrate;

the TFT substrate comprises a glass substrate, a gate and a scan line located on the glass substrate, a gate isolation layer being located on the glass substrate and covering the gate and the scan line, an active layer being located above the gate and on the gate isolation layer, a source/a drain located on the active layer and the gate isolation layer, a data line located on the gate isolation layer, a passivation layer being located on the gate isolation layer and covering the source/the drain and the data line, a patterned pixel electrode located on the passivation layer and a flat layer covering the pixel electrode and the passivation layer; the pixel electrode contacts with the source/the drain with a passivation layer via hole;

the liquid crystal layer dissolves auxiliary alignment agent, and the auxiliary alignment agent makes the liquid crystal molecules vertically aligned on the surface of the TFT substrate;

the flat layer makes the surface property of the TFT substrate homogenized, and accordingly, an acting force of the auxiliary alignment agent and the surface of the TFT substrate is homogenized.

The flat layer is a silicon nitride layer, a silicon dioxide layer, an aluminum oxide layer, a zirconium oxide layer or a titanium oxide layer.

A thickness of the flat layer is 50 nm-1000 nm.

The flat layer is formed by chemical vapor deposition.

The benefits of the present invention are: the present invention provides a vertical alignment liquid crystal display, improving the present liquid crystal display of which the vertical alignment is implemented to the liquid crystal molecules with auxiliary alignment agent, and by forming the passivation layer and a contact layer of the pixel electrode to be oxide layers of which the surface property is similar with the pixel electrode; or by forming a flat layer covering the pixel electrode, an acting force of the auxiliary alignment agent dissolved in the liquid crystal layer and the surface of the TFT substrate is homogenized to solve the defect problems of aligning force difference and bright, dark lines display caused by the patterning of the pixel electrode.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a sectional diagram of a vertical alignment liquid crystal display using alignment layers according to prior art;

FIG. 2 is a top view diagram of one side of a lower substrate in an MVA liquid crystal display using alignment layers according to prior art;

FIG. 3 is a sectional diagram of an MVA liquid crystal display using alignment layers according to prior art;

FIG. 4 is a sectional diagram of a vertical alignment liquid crystal display using auxiliary alignment agent according to prior art;

FIG. 5 is a sectional diagram showing a first embodiment of a vertical alignment liquid crystal display according to the first implement of the present invention;

FIG. 6 is a sectional diagram showing a second embodiment of a vertical alignment liquid crystal display according to the first implement of the present invention;

FIG. 7 is a top view diagram of one side of a TFT substrate in the vertical alignment liquid crystal display according to the first implement of the present invention;

FIG. 8 is a sectional diagram showing the second implement of the vertical alignment liquid crystal display according to the present invention;

FIG. 9 is a top view diagram of one side of a TFT substrate in the vertical alignment liquid crystal display according to the second implement of the present invention.

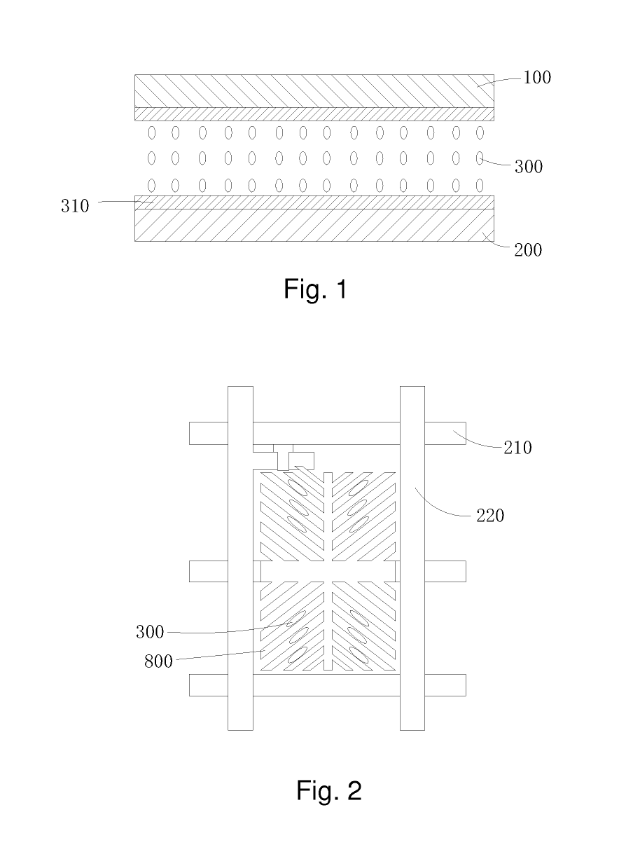

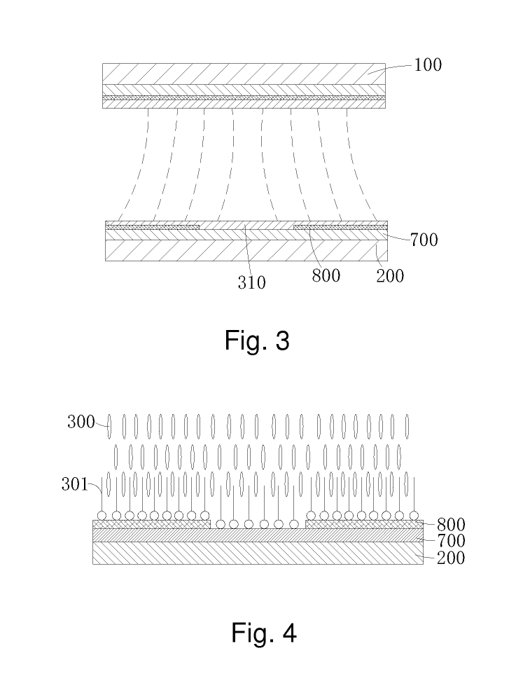

### DETAILED DESCRIPTION OF PREFERRED EMBODIMENTS

For better explaining the technical solution and the effect of the present invention, the present invention will be further described in detail with the accompanying drawings and the specific embodiments.

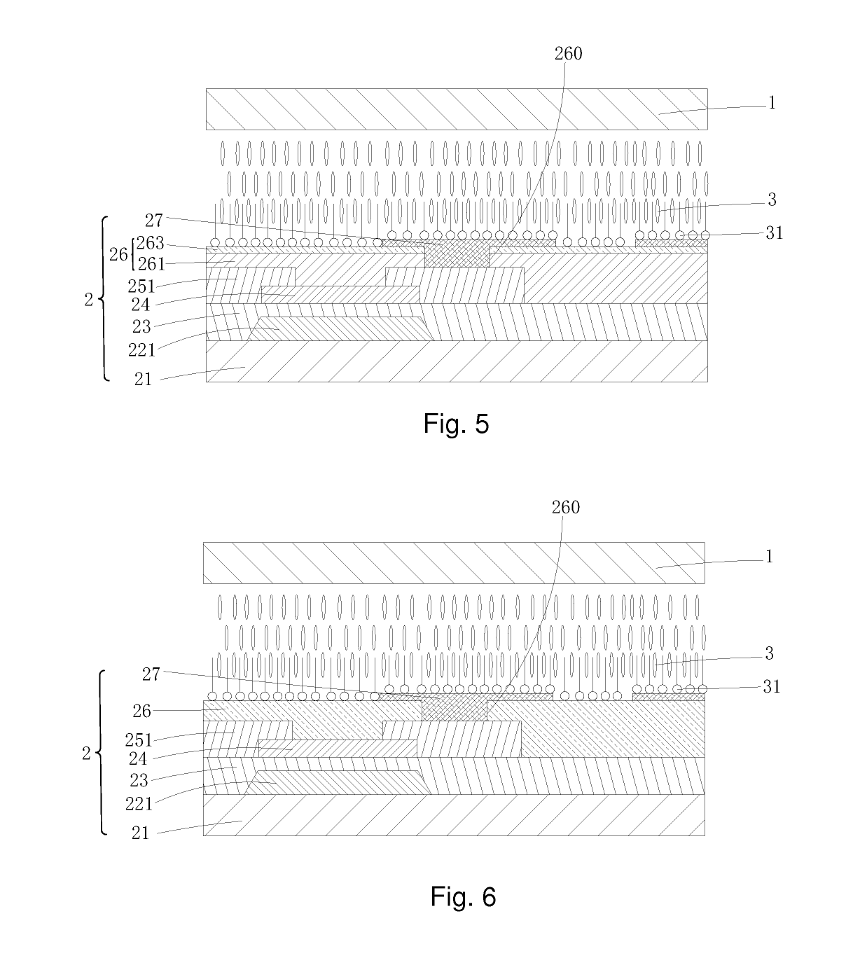

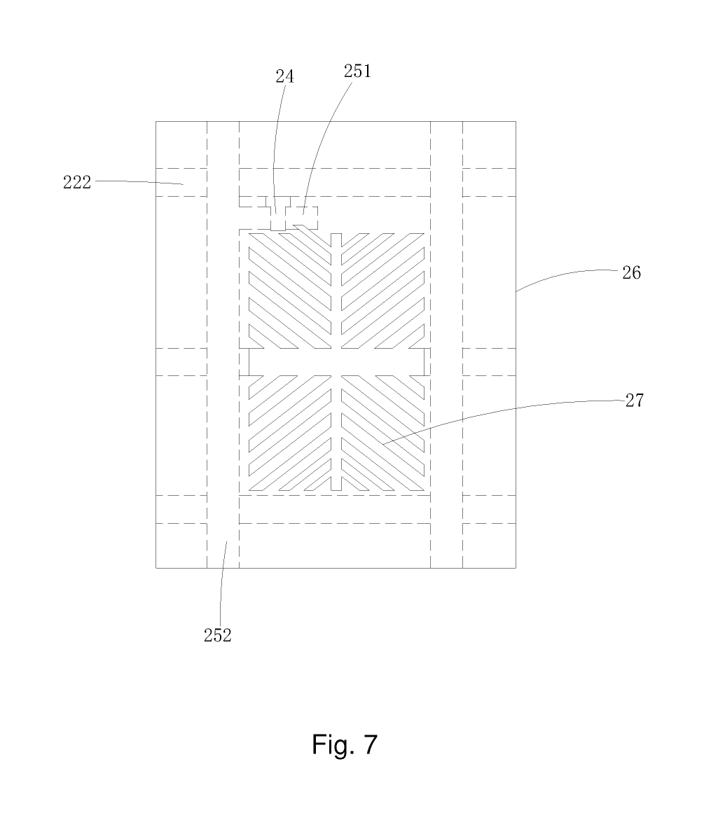

Please refer to FIG. 5 and FIG. 7, showing a first embodiment of a vertical alignment liquid crystal display according to the first implement of the present invention. The vertical alignment liquid crystal display comprises a CF substrate 1, a TFT substrate 2, oppositely located with the CF substrate 1 and a liquid crystal layer 3 located between the CF substrate 1 and the TFT substrate 2.

The liquid crystal layer 3 dissolves auxiliary alignment agent 31. One end of molecules of the auxiliary alignment agent 31 possesses special affinity with the surfaces of the TFT substrate 2 and CF substrate 1, and can attach to the surfaces of the TFT substrate 2 and CF substrate 1, and the other end of molecules of the auxiliary alignment agent 31 has extremely strong acting force with the liquid crystal molecules in the liquid crystal layer 3, and thus, the liquid crystal molecules are vertical aligned with the surfaces of the TFT substrate 2 and CF substrate 1. Compared with the present vertical alignment liquid crystal display using PI alignment films, the present invention does not use the PI alignment film but the auxiliary alignment agent 31 for achieving the vertical alignment of the liquid crystal molecules. Thus, a mass of harmful solvent involved in the PI alignment film process and high temperature baking process can be eliminated, and the machine and the power consumption can be saved. It is more environmental protective, more energy saved, and can reduce the yield lost due to the poor P1.

The TFT substrate 2 comprises a glass substrate 21, a gate 221 and a scan line 222 located on the glass substrate 21, a gate isolation layer 23 being located on the glass substrate 21 and covering the gate 221 and the scan line 222, an active layer 24 being located above the gate 221 and on the gate isolation layer 23, a source/a drain 251 located on the active layer 24 and the gate isolation layer 23, a data line 252 located on the gate isolation layer 23, a passivation layer 26 being located on the gate isolation layer 23 and covering the source/the drain 251 and the data line 252 and a patterned pixel electrode 27 located on the passivation layer 26; the pixel electrode 27 contacts with the source/the drain 251 with a passivation layer via hole 260. Specifically, the pixel electrode 27 has a pozidriv slit pattern, located in a district defined by intersection of the scan lines 222 and the data lines 252.

The passivation layer 26 is formed by chemical vapor deposition (CVD), and at least comprises one layer, wherein a contact layer of the pixel electrode 27 is an oxide layer of which a surface property is similar with the pixel electrode 27. The oxide layer of which the surface property is similar with the pixel electrode 27 is a silicon dioxide (SiO2) layer, an aluminum oxide (Al2O3) layer, a zirconium oxide (ZrO2) layer or a titanium oxide (TiO2) layer. In the first embodiment shown in FIG. 5, the passivation layer 26 comprises a double layer structure comprising a topside layer 263 and other layers 261. The topside layer 263 is a contact layer of the pixel electrode 27, i.e. the topside layer 263 is an oxide layer of which a surface property is similar with the pixel electrode, such as a silicon dioxide layer, an aluminum oxide layer, a zirconium oxide layer or a titanium oxide layer; the other layers 261 can be a silicon nitride layer, a silicon dioxide layer, an aluminum oxide layer, a zirconium oxide layer or a titanium oxide layer. For instance, the composition of the passivation layer 26 can be a silicon nitride layer and a silicon dioxide layer, or a silicon nitride layer and an aluminum oxide layer, or a silicon nitride layer and a zirconium oxide layer, or a silicon nitride layer and a titanium oxide layer, or a silicon dioxide layer and an aluminum oxide layer, or a silicon dioxide layer and a zirconium oxide layer, or a silicon dioxide layer and a titanium oxide layer.

Certainly, the passivation layer 26 can comprise a triple layer structure, and the topside layer 263 is a contact layer of the pixel electrode 27; the other layers 261 of the passivation layer 26 are two of the silicon nitride layer, the silicon dioxide layer, the aluminum oxide layer, the zirconium oxide layer or the titanium oxide layer. For instance, the composition of the passivation layer 26 can be a silicon nitride layer, a silicon dioxide layer and an aluminum oxide layer, or a silicon nitride layer, a silicon dioxide layer and a zirconium oxide layer, or a silicon nitride layer, an aluminum oxide layer and a zirconium oxide layer.

In the first embodiment, the passivation layer 26 is improved from the present single silicon nitride layer structure to a double or triple layer structure, wherein the topside layer 263 contacting with the pixel electrode 27 is a silicon dioxide layer, an aluminum oxide layer, a zirconium oxide layer or a titanium oxide layer. Because the material of the pixel electrode 27 is Indium Tin Oxide, which is also a kind of oxide and possesses the surface property closer to the surface energy as the silicon dioxide, aluminum oxide, zirconium oxide or titanium oxide. Therefore, the acting force difference among the auxiliary alignment agent 31 dissolved in the liquid crystal layer 3 and the surfaces of the different districts of the TFT substrate 2 can be reduced. Thus, the acting force of the auxiliary alignment agent 31 and the surface of the TFT substrate 2 is homogenized to solve the defect problems of aligning force difference and bright, dark lines display caused by the patterning of the pixel electrode 27.

Please refer to FIG. 6 and FIG. 7, showing a second embodiment of a vertical alignment liquid crystal display according to the first implement of the present invention. The difference of the second embodiment from the first embodiment is, the passivation layer 26 is a single layer structure, and the single passivation layer 26 is a contact layer of the pixel electrode 27, i.e. the single passivation layer 26 is a silicon dioxide layer, an aluminum oxide layer, a zirconium oxide layer or a titanium oxide layer, which can similarly reduce the acting force difference among the auxiliary alignment agent 31 dissolved in the liquid crystal layer 3 and the surfaces of the different districts of the TFT substrate 2. Thus, the acting force of the auxiliary alignment agent 31 and the surface of the TFT substrate 2 is homogenized to solve the defect problems of aligning force difference and bright, dark lines display caused by the patterning of the pixel electrode 27. Others are the same as the first embodiment. The repeated description is omitted here.

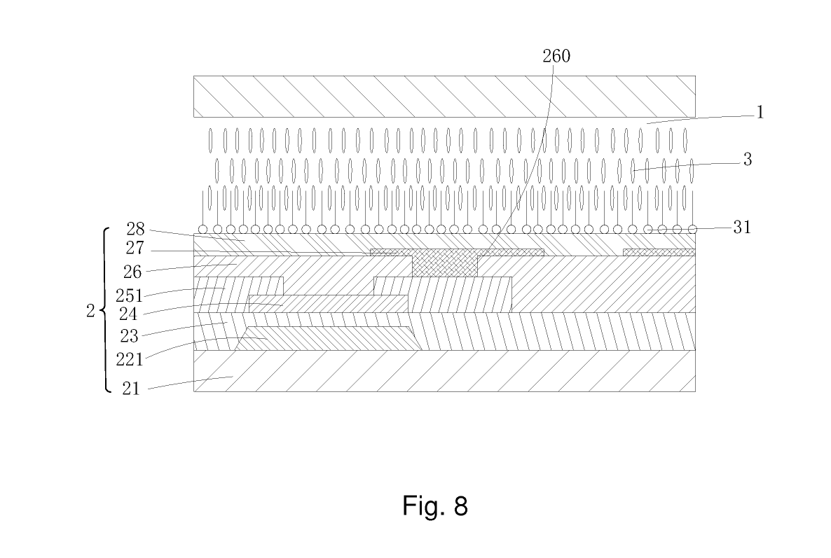

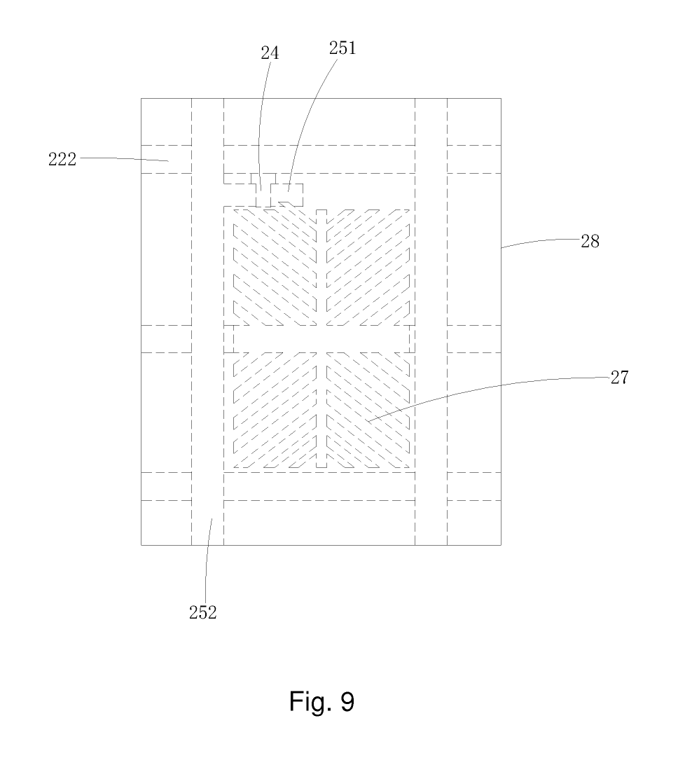

Please refer to FIG. 8 and FIG. 9, showing a second implement of a vertical alignment liquid crystal display according to the present invention. The vertical alignment liquid crystal display comprises a CF substrate 1, a TFT substrate 2, oppositely located with the CF substrate 1 and a liquid crystal layer 3 located between the CF substrate 1 and the TFT substrate 2.

The liquid crystal layer 3 dissolves auxiliary alignment agent 31. One end of molecules of the auxiliary alignment agent 31 possesses special affinity with the surfaces of the TFT substrate 2 and CF substrate 1, and can attach to the surfaces of the TFT substrate 2 and CF substrate 1, and the other end of molecules of the auxiliary alignment agent 31 has extremely strong acting force with the liquid crystal molecules in the liquid crystal layer 3, and thus, the liquid crystal molecules are vertical aligned with the surfaces of the TFT substrate 2 and CF substrate 1. Compared with the present vertical alignment liquid crystal display using PI alignment films, the present invention does not use the PI alignment film but the auxiliary alignment agent 31 for achieving the vertical alignment of the liquid crystal molecules. Thus, a mass of harmful solvent involved in the PI alignment film process and high temperature baking process can be eliminated, and the machine and the power consumption can be saved. It is more environmental protective, more energy saved, and can reduce the yield lost due to the poor PI.

The TFT substrate 2 comprises a glass substrate 21, a gate 221 and a scan line 222 located on the glass substrate 21, a gate isolation layer 23 being located on the glass substrate 21 and covering the gate 221 and the scan line 222, an active layer 24 being located above the gate 221 and on the gate isolation layer 23, a source/a drain 251 located on the active layer 24 and the gate isolation layer 23, a data line 252 located on the gate isolation layer 23, a passivation layer 26 being located on the gate isolation layer 23 and covering the source/the drain 251 and the data line 252, a patterned pixel electrode 27 located on the passivation layer 26 and a flat layer 28 covering the pixel electrode 27 and the passivation layer 26; the pixel electrode 27 contacts with the source/the drain 251 with a passivation layer via hole 260. Specifically, the pixel electrode 27 has a pozidriv slit pattern, located in a district defined by intersection of the scan lines 222 and the data lines 252.

In the second embodiment, there is no special requirement for the passivation layer 26, and a silicon nitride layer as the same as prior art can be employed. The flat layer 28 is formed by chemical vapor deposition, and a thickness thereof is 50 nm-1000 nm. The flat layer 28 can be a silicon nitride layer, a silicon dioxide layer, an aluminum oxide layer, a zirconium oxide layer or a titanium oxide layer.

The flat layer 28 covers the pixel electrode 27 and the passivation layer 26 to homogenize the surface property of the TFT substrate 2, which can similarly reduce the acting force difference among the auxiliary alignment agent 31 dissolved in the liquid crystal layer 3 and the surfaces of the different districts of the TFT substrate 2. Thus, the acting force of the auxiliary alignment agent 31 and the surface of the TFT substrate 2 is homogenized to solve the defect problems of aligning force difference and bright, dark lines display caused by the patterning of the pixel electrode 27.

In conclusion, the present invention provides a vertical alignment liquid crystal display, improving the present liquid crystal display of which the vertical alignment is implemented to the liquid crystal molecules with auxiliary alignment agent, and by forming the passivation layer and a contact layer of the pixel electrode to be oxide layers of which the surface property is similar with the pixel electrode; or by forming a flat layer covering the pixel electrode, an acting force of the auxiliary alignment agent dissolved in the liquid crystal layer and the surface of the TFT substrate is homogenized to solve the defect problems of aligning force difference and bright, dark lines display caused by the patterning of the pixel electrode.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A vertical alignment liquid crystal display, comprising a CF substrate, a TFT substrate, oppositely located with the CF substrate and a liquid crystal layer located between the CF substrate and the TFT substrate;
the TFT substrate comprises a glass substrate, a gate and a scan line located on the glass substrate, a gate isolation layer being located on the glass substrate and covering the gate and the scan line, an active layer being located above the gate and on the gate isolation layer, a source/a drain located on the active layer and the gate isolation layer, a data line located on the gate isolation layer, a passivation layer being located on the gate isolation layer and covering the source/the drain and the data line and a patterned pixel electrode located on the passivation layer; the pixel electrode contacts with the source/the drain with a passivation layer via hole;
the liquid crystal layer dissolves auxiliary alignment agent, and the auxiliary alignment agent makes the liquid crystal molecules vertically aligned on the surface of the TFT substrate.
the passivation layer at least comprises one layer, wherein a contact layer of the pixel electrode is an oxide layer of which a surface property is similar with the pixel electrode to homogenize an acting force of the auxiliary alignment agent and the surface of the TFT substrate.

2. The vertical alignment liquid crystal display according to claim 1, wherein the oxide layer of which the surface property is similar with the pixel electrode is a silicon dioxide layer, an aluminum oxide layer, a zirconium oxide layer or a titanium oxide layer.

3. The vertical alignment liquid crystal display according to claim 2, wherein the passivation layer comprises a double layer or triple layer structure, comprising a topside layer and other layers, and the topside layer is a contact layer of the pixel electrode; the other layers are one or two of the silicon nitride layer, the silicon dioxide layer, the aluminum oxide layer, the zirconium oxide layer or the titanium oxide layer.

4. The vertical alignment liquid crystal display according to claim 2, wherein the passivation layer comprises a single layer structure, and the single passivation layer is a contact layer of the pixel electrode.

5. The vertical alignment liquid crystal display according to claim 1, wherein the passivation layer is formed by chemical vapor deposition.

6. A vertical alignment liquid crystal display, comprising a CF substrate, a TFT substrate, oppositely located with the CF substrate and a liquid crystal layer located between the CF substrate and the TFT substrate;
the TFT substrate comprises a glass substrate, a gate and a scan line located on the glass substrate, a gate isolation layer being located on the glass substrate and covering the gate and the scan line, an active layer being located above the gate and on the gate isolation layer, a source/a drain located on the active layer and the gate isolation layer, a data line located on the gate isolation layer, a passivation layer being located on the gate isolation layer and covering the source/the drain and the data line, a patterned pixel electrode located on the passivation layer and a flat layer covering the pixel electrode and the passivation layer; the pixel electrode contacts with the source/the drain with a passivation layer via hole;
the liquid crystal layer dissolves auxiliary alignment agent, and the auxiliary alignment agent makes the liquid crystal molecules vertically aligned on the surface of the TFT substrate;
the flat layer makes the surface property of the TFT substrate homogenized, and accordingly, an acting force of the auxiliary alignment agent and the surface of the TFT substrate is homogenized.

7. The vertical alignment liquid crystal display according to claim 6, wherein the flat layer is a silicon nitride layer, a silicon dioxide layer, an aluminum oxide layer, a zirconium oxide layer or a titanium oxide layer.

8. The vertical alignment liquid crystal display according to claim 6, wherein thickness of the flat layer is 50 nm-1000 nm.

9. The vertical alignment liquid crystal display according to claim 6, wherein the flat layer is formed by chemical vapor deposition.

10. A vertical alignment liquid crystal display, comprising a CF substrate, a TFT substrate, oppositely located with the CF substrate and a liquid crystal layer located between the CF substrate and the TFT substrate;
the TFT substrate comprises a glass substrate, a gate and a scan line located on the glass substrate, a gate isolation layer being located on the glass substrate and covering the gate and the scan line, an active layer being located above the gate and on the gate isolation layer, a source/a drain located on the active layer and the gate isolation layer, a data line located on the gate isolation layer, a passivation layer being located on the gate isolation layer and covering the source/the drain and the data line, a patterned pixel electrode located on the passivation layer and a flat layer covering the pixel electrode and the passivation layer; the pixel electrode contacts with the source/the drain with a passivation layer via hole;
the liquid crystal layer dissolves auxiliary alignment agent, and the auxiliary alignment agent makes the liquid crystal molecules vertically aligned on the surface of the TFT substrate;
the flat layer makes the surface property of the TFT substrate homogenized, and accordingly, an acting force of the auxiliary alignment agent and the surface of the TFT substrate is homogenized;
wherein the flat layer is a silicon nitride layer, a silicon dioxide layer, an aluminum oxide layer, a zirconium oxide layer or a titanium oxide layer;
wherein a thickness of the flat layer is 50 nm-1000 nm;
wherein the flat layer is formed by chemical vapor deposition.
